(19) United States
(12) Patent Application Publication
(10) Pub. No.: US 2013/0300535 A1
(43) Pub. Date: Nov. 14, 2013

(54) Fire Fighting System

(71) Applicant: Walter Gorman, Cameron, MO (US)

(72) Inventor: Walter Gorman, Cameron, MO (US)

(21) Appl. No.: 13/470,324

(22) Filed: May 13, 2012

(51) Int. Cl. G08B 5/22

(52) U.S. Cl. 340/6.1

(57) ABSTRACT

A system for identifying and aiding a firefighter may include a pocket monitor to be carried by the firefighter, and a command center to be wirelessly connected to the pocket monitor. The pocket monitor may include a lost switch to communicate with the command center that the fire fighter is lost, may include a trapped switch to communicate with the command center that the firefighter is trapped and may include a injured switch to communicate with the command center that the firefighter is injured. The pocket monitor may include a video camera, and the pocket monitor may include a telephone switch to enable the firefighter to make a telephone call. The pocket monitor may include a touch screen, and the pocket monitor may include a temperature detector.

### FIELD OF THE INVENTION

The present invention relates to firefighting equipment and more particularly to a command center, fire suit and a pocket monitor.

### BACKGROUND

The art of firefighting has improved greatly over the years, but firefighting remains a dangerous occupation for the firefighters. Improvements in equipment including communication equipment can significantly reduce the mortality rate of firefighters.

US patent application 2007/0103294 discloses systems and methods which may enable first incident responder management and support. System and methods enabled by software may utilize communications networks and location based systems such as the Global Positioning System (GPS) to locate the incident and response units, and to relay and share critical incident management information for use by other emergency response operators associated with an emergency scene. Maps and icons may be accessed and utilized over devices in the field. Software modules enable a system operator to use maps and a selection of user interface objects such as custom icons symbolizing a list of responders (police, fire, rescue, military) called forward and may designate specific geographic positions for managing a crisis.

U.S. Pat. No. 7,634,156 discloses a building's scaled plans being integrated in a single system. The structural, electrical, water, fire alarm, motion detection, and other various assorted systems are all integrated into the same system. Thus, they are easily accessible to emergency personnel. The emergency personnel will have immediate access to data gathered by the alarm system thereby notifying emergency personnel immediately of the location of hazardous situations as well as where potential victims or, in the event of a crime where, perpetrators may be. The system can also be used to plan ingress and egress routes or point-to-point routes and distances. Further, emergency planning for other structures such as bridges and tunnels can be performed using the disclosed system. Additionally, GPS locators can be used to track personnel.

U.S. Pat. No. 6,198,914 discloses that upon occurrence of any emergent state for a user, the user depresses an emergency call button of his portable telephone to transmit a signal therefrom to an emergency call center, whereby user ID and positional information of the portable telephone obtained on the basis of signals from GPS satellites are sent to the emergency call center. DGPS generates a correcting signal out of the positional information based on both the signals from the GPS satellites and the positional information of a fixed station, and then transmits such correcting signal to the emergency call center. In response to a terminating call from the portable telephone and reception of the user ID, the emergency call center outputs the individual information of the user to a display device and corrects the positional information of the portable telephone in accordance with the correcting signal, and makes contact with a hospital or a fire station while displaying the map information of the vicinity around the corrected position on the display device.

### SUMMARY

A system for identifying and aiding a firefighter may include a pocket monitor to be carried by the firefighter, and a command center to be wirelessly connected to the pocket monitor. The pocket monitor may include a lost switch to communicate with the command center that the fire fighter is lost, may include a trapped switch to communicate with the command center that the firefighter is trapped and may include a injured switch to communicate with the command center that the firefighter is injured.

The pocket monitor may include a video camera, and the pocket monitor may include a telephone switch to enable the firefighter to make a telephone call.

The pocket monitor may include a touch screen, and the pocket monitor may include a temperature detector.

The pocket monitor may include a compass, and the pocket monitor may include a gas detector.

The pocket monitor may include an evacuate display to allow the command center to evacuate the firefighter, and the pocket monitor may include a text message mode switch to allow the firefighter to send and receive text messages.

The pocket monitor may include a floor plan switch to display the floor plan of the building being currently occupied by the firefighter.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a front view of the pocket monitor of the present invention;

FIG. 2 illustrates a side perspective view of the pocket monitor of the present invention;

FIG. 3 illustrates an opposing side perspective view of the pocket monitor of the present invention;

FIG. 4 illustrates an interior view of the command center of the present invention; and

FIG. 5 illustrates a perspective view of the coat of the firemen of the present invention.

### DETAILED DESCRIPTION

### The Unit

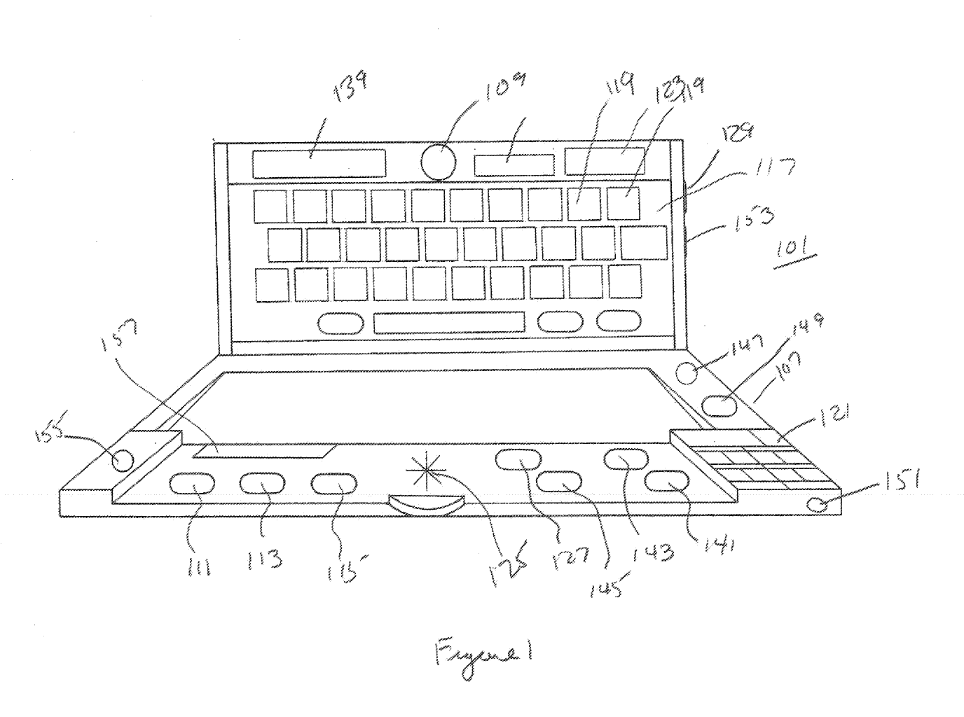

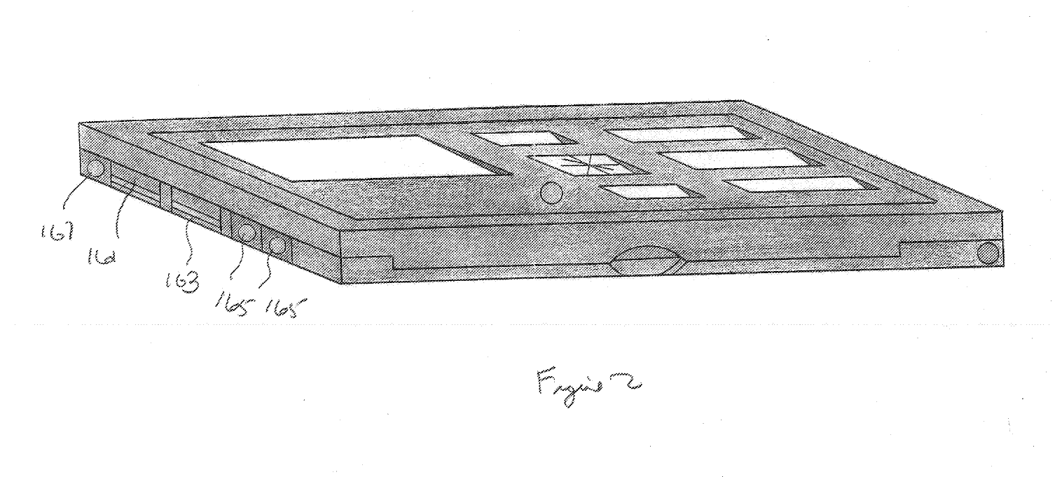

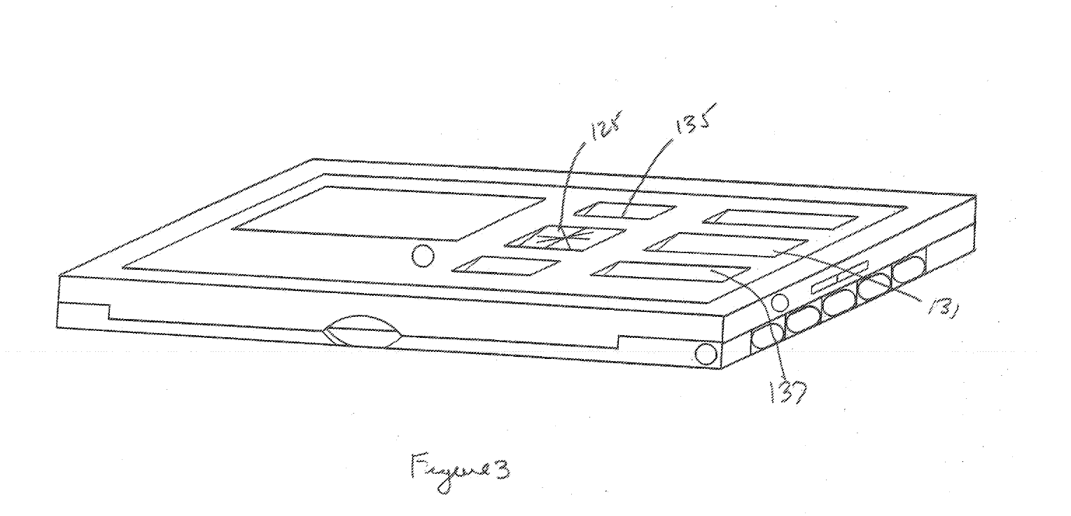

The Unit 100 as illustrated in FIGS. 1-3 which may be carried by firefighters is a device which includes a processor to operate a computer program so as to track the firefighter and pinpoint the physical location of a firefighter when in the line of duty or in other situations, using a global positioning satellite device G.P.S or other types of location devices to provide the physical location to the unit 100.

The unit 100 which may be carried by firefighters may be designed to help and facilitate the efforts of firefighters to escape from their dubious, dangerous or precarious positions and burning structures, should they ever become lost, trapped, injured, disorientated, overcome by smoke inhalation or other situations in which there is a need to escape from while in the line of duty.

The unit 100 may include three (3) components:

1) A pocket monitor 101 for each firefighter which may be pocket-sized or other convenient size.

2) A fire coat 103 to be worn by the firemen.

3) A Mobilized Command Center 105 to coordinate the activities of the firemen within a specified group.

### The Pocket Monitor 101

The dimensions of the pocket monitor 101 may be substantially 6½ inches long, 3¼ inches wide, ¾ inches in depth or other size. The pocket monitor may be sized to fit into a standard pocket. The weight of the pocket monitor 101 may be approximately 4.5 oz. or other appropriate weight. The housing 107 may be formed from metal, plastic or other appropriate material such as translucent polycarbonate plastic and should be formed to be rugged, withstand high temperature, and withstand impacts.

The pocket monitor 101 may comply current National Fire Protection Agency specifications and may be safe for use in Class I, Division 1, Groups A, B, C, and D hazardous locations and may comply with other specifications.

The pocket monitor 101 may be designed to clip onto the outer protective garment of the firefighter or may be worn on the left sleeve of the fire coat or even held or carried by hand. This provides easy access to the pocket monitor 101 and may allow the firefighter to feel the vibration motion which may be generated by the pocket monitor 101 and which may alert the firefighter of incoming information from the Mobile Command Center 105.

The pocket monitor 101 may be a computerized unit with a processor within the housing 107 to provide eight (8) predetermined functions or more and capabilities that may be readily accessible at the fingertips of the firefighter to communicate with the Mobile Command Center 105 to help the firefighter to navigate his way through any structure, and the pocket monitor 101 may include a video camera 109 to preserve or document by way of a still photos or video camera, the situation, from his perspective as it unfolds or develops. These functions and capabilities may be as follows:
1. Three (3) touch screen switches, identified as “Specific Distress Keys” may be switches to indicate a lost, a trapped or an injured firemen. The switches may be the lost switch 111 to indicate that the firemen is lost within the building, the trapped switch 113 to indicate that the firemen is trapped within the building and the injured switch 115 to indicate that the firemen has been injured. The switches may be located along the front of the pocket monitor 101.
2. A touch screen monitor 117, to display on command, the floor plans, blueprints, and-or schematics of the structure in question and in so doing, show the firefighter's location for example with a flashing dot (.), exactly, within that structure. The floor plan switch 145 may activate this function. The touchscreen 117 may be a three-way touchscreen to show upon command of the firefighter, the floor plans, blueprints or schematics of any structure within the city limits of a given city. The touchscreen 117 may also display a keyboard to write and send text messages, and the touchscreen 117 may be capable of displaying a telephone keypad to make phone calls. The text message mode switch 143 controls the mode of the text messages. The telephone received switch 147 activates the phone call procedure.
3. A keyboard 119 may be arranged as a typewriter keyboard and maybe formed on the touchscreen 117 which may allow the firefighter to communicate with the Mobile Command Center 105 via the text message mode in the event the 2-way radio of the firefighter malfunctions. The firefighter may also be able to send text messages to loved ones or friends should it be determined by the Battalion Chief that he/she may not be extracted alive and the friend or loved one may not be reached by phone.

### 1

4, A mega pixel, high resolution camera and video recorder 109 to allow the firefighter to take still photos, to record and to send live coverage of what the firefighter sees inside the structure back to the Mobile Command Center 105 for consultation, assessment and instructions, and to preserve the scene from the perspective of the firefighter as the scene develops. The camera 109 may be positioned on the upper edge of the touchscreen 117.
   This function of the pocket monitor 101 may be advantageous because this function allows the firefighter to show fire officials within the Mobile Command Center 105 (with the task of extracting the lost, trapped or injured firemen from harms way) the situation as it develops in real time. The video link from the pocket monitor 101 may provide the chief or other fire official with the information of how to enter the location where the lost, trapped or injured firefighter may be found. Additionally, the unit 100 may also allow the Chief or other fire official to assess the extent of any injuries of the firemen, which will then allow paramedics to carry the proper equipment to the injured firefighter so as to stabilize him until he can be extracted and transported for proper medical care.
5. A gas detector 121 which may detect and determine high or life threatening levels of Radon, Carbon Monoxide, Methane and Natural gases. The gas detector 121 may include a sensor may also detect trace particles of Asbestos dust, so as to limit exposure to contracting Mesothelioma. The asbestos indicator 149 may provide an indication of the amount of asbestos dust.

The power indicator 151 may indicate if the pocket monitor 101 is activated. The scroll switch 153 controls the scrolling of the touchscreen 117.
6. A thermometer detector 123 which may be a digital detector may display and warn firefighters of dangerous high temperatures when the temperature exceeds a threshold predetermined value.
7. A digital compass 125 with a latitude and longitudinal indicator 157 may be positioned on the front of the monitor 101 to keep the firefighter aware of his location/bearings.
8. The monitor 101 may include a telephone mode switch 127 to activate communication over the telephone and may be available to be used as a last resort when it may be determined that due to various reasons, the firefighter may not be extracted alive. Consequently, the firefighter may wish to talk with spouse, children, parent, friends, relatives or clergy in this situation, and the telephone service may be available for the firefighter to make as many calls as the circumstance will allow. The firefighter may have the option to speed-dial pre-programmed numbers or free-dial any number and to talk for as long as the firefighter desires on a secured line. The phone voice transmitter switch 155 switches the phone transmitter on and off.

The pocket monitor 101 may include a memory card portal 151 positioned along the side of the pocket monitor 101, and a Wi-Fi portal 163 for the pocket monitor 101 may be positioned along the side of the pocket monitor 101 to provide Wi-Fi connection. In addition, an auxiliary AC/DC port 165 may be positioned along the side of the pocket monitor 101 to connect to external power. The pocket monitor 101 may include a digital clock including a display 159 to display the time and may include a headset connection 167 which may facilitate connection to a headset. The outer surface of the pocket monitor 101 may include a personal identifier 169 to identify the firefighter.

### Function, Capability No. 1

The present invention may include a multitude of distress switches. Each of the distress switches may be labeled to correspond to the specific situation which the firefighter may want to convey to the mobile command center 105 or as close to the specific situation that the firefighter may find himself in and wants to signal the mobile command center 105 for help. The distress switches may include three distress switches will read as follows:
1. A lost switch 111 to communicate with the mobile command center 105 that the firefighter is lost within the structure.
2. A trapped switch 113 to communicate with the mobile command center 105 that the firefighter is trapped within the structure.
3. An injured switch 115 to communicate with the mobile command center 105 that the firefighter is injured and needs assistance.
   When the firefighter activates either one of the distress switches 111, 113, 115 the following is designed and programmed to occur:
   Example No. 1. Assume that the firefighter has distress switch 113 which may indicate a trapped firemen.

When the firefighter opens the pocket monitor 101 for whatever reason, immediately upon doing so, a signal (his personal signal) and all other pertinent information that identifies him is transmitted to the mobile command center 105. In the above example, the firefighter has indicated that he is trapped.

On the monitor 201 which may be the second largest within the mobile command center 105, the floor plans of the structure which the firefighter is positioned is displayed and the location of the trapped firefighter may be on display for the Battalion Chief and other personnel with the tasks of rescuing the trapped firefighter.

The monitors 203, 205 which may be smaller and positioned to the left of the monitor 201 may display the following information regarding the trapped firefighter:

1.) Full legal name of firefighter
2.) The number assigned to the Pocket Monitor 101
3.) Station House number
4.) Immediate supervisor
5.) Emergency contact information for the next of kin

Additionally, a live video may be positioned to the right of the monitor 201, one of the top (2) smaller monitors 207, 209 and may be designed to show a live feed of the trapped firefighters unique situation, so that the Battalion Chief can see how his firefighter is trapped and by what resources are needed to free the firefighter. This feature may be available providing the firefighter can get to the pocket-monitor 101 and activate the video-mode.

With this live video feed from the perspective of the trapped firefighter, the Chief may be able to assess the situation without guessing or placing other firefighters in harms way, unnecessarily. This feature may also allow the Chief to know the best way to enter the location of the trapped firefighter without further causing harm. In the event that the trapped firefighter can't get to his pocket monitor 101, the Chief will know the exact location of the next firefighter that is in the closest proximity of the trapped firefighter and direct the next firefighter there so as to get a live video feed of the trapped firefighter situation.

The floor plan of the structure in question, that is being displayed on the second largest monitor 201 within the Mobile Command Center, will be shown in 3-D mode, until the Trapped firefighter has been extracted.

If or should the firefighter activates and the distress switch which may be labeled the lost switch 111 or the injured switch 115, the above activity should still occur, with minor adjustments to accommodate or fit the distressed situation.

### Function, Capability No. 2

The pocket monitor 101 may be designed and programmed to archive and store the floor plans, blueprints and schematics of every structure, new or old within the City Limits of any given city and upon command from the Mobile Command Center 105 or the 9-1-1 dispatcher, the pocket monitor 101 may receive a download of the floor plan, blueprint or schematic while the firefighter is responding to the location.

When at the scene of the structure in question, the firefighter should always know (as well as the Chief, inside the Mobile Command Center 105) his exact pinpointed location within the structure by opening the pocket monitor 101, and the pocket monitor 101 may display the location by a flashing dot (.) superimposed on the floor plans of the structure.

### Function, Capability No 3

The top screen 117 inside the pocket monitor 101 may include at least (3) functions, or purposes: Function One may be designed and programmed to display or show the floor plans, blueprints or schematics of a structure, when commanded to do so by a 9-1-1-dispatcher or the Battalion Chief within the Mobile Command Center 105, and floor plans, blueprints or schematics of the structure may be as downloaded onto the pocket monitor 101 of any and all firefighters ordered or summoned to respond to that address.

Function two may be designed and programmed to display or show a keyboard upon command by the firefighter desiring or needing to send a Text Message to the mobile command center 105 or to loved ones when approved by the Battalion Chief

Function three may be designed and programmed to display upon command by firefighter who may be in harms way and may not be rescued or extracted alive, a telephone menu to place telephone calls to spouse, children, parents, friends or clergy via speed-dial or free-dial on a secured phone line.

The Text Message feature/function may be included so as to provide the firefighter and the Mobile Command Center 105 with another way to communicate with each other in the event 2-way radio communication is interrupted, disconnected or otherwise interfered with.

### Function, Capability No. 4

The pocket monitor 101 may include a mega pixel high-resolution video camera 109 and/or a high-resolution mega pixel camera to allow the firefighter the ability to capture via video or still photographs, images of the situation as it develops to preserve evidence within the pocket monitor 101 in case of a potential crime scene and to be used as a training tool.

To activate the video recorder to feed a live image or coverage from the firefighter perspective to the Mobile Command Center where said imaging will be recorded, the firefighter may locate the video recording mode switch 141 on his pocket monitor 101 and activate video recording by pressing that switch 141. The switch 141 may be located along a side of the pocket monitor 101 and may turn red and give off a continued flashing while recording. To discontinue recording, the firefighter may press the switch 141 again.

To take a still photograph, the firefighter may use the switch 129 which may be positioned on the top outer right side of his pocket monitor 101 to obtain a desired photo, and the desired photo maybe stored onto a memory card to be later downloaded and printed by computer.

### Function, Capability No. 5

This function of the pocket monitor 101 may give the firefighter an advanced warning of the presence of high and/or life threatening levels of Radon, Methane, Carbon Monoxide and Natural Gas gasses that may not always be seen, smelled or tasted. Additionally, this detector 121 may be also capable and designed to detect dust particles of Asbestos and to provide a warning.

When one or more of the above mentioned gases are detected, detector 121 of the pocket monitor 101 may detect, record in memory and display the gas or gasses and determine and display the percentage of the particular gas detected. If more than one of the gases is detected by the detector 121, all of the detected gases may be identified and the percentage of each of the gases may be stored in memory, but whichever gas is the most dominate of the detected gases, this gas may be the one that may show or be displayed on the first display 131 of the pocket monitor 101, yet the detector 121 may reset in a predetermined interval such as a 2 minute intervals to display the names and percentages of the lesser gases detected.

Immediately under the name and percentage reader which may be displayed on a second display 133, is (4) departments or sections divided into two halves. These may be LCD lights, green on one side, red on the other. These lights may register the presence of the above (4) gases, if Radon Gas is detected, then the Radon section of this grid will show with the red light side, that the detector 121 of the pocket monitor 101 has detected Radon gas and the pocket monitor 101 may display in a similar way the other (3) gases. Function, Capability No 5 of the pocket monitor 101 may not be activated, but the capacity may be always on in detection mode.

### Function, Capability No. 6

The pocket monitor 101 may include a digital thermometer which may be connected to a third display 135 to determine the temperature of the firefighters immediate environment or surrounding and to alert the firefighter of dangerous temperatures. The third display 135 may help the firefighter to determine the degree of risk to perusing his efforts to extinguish the fire as well as the degree of risk to his life and equipment.

In addition to being able to see and read the temperature in a digital setting, the firefighter may also hear a series of audio alarms such as bells or visual alarms to indicate that the thermometer may be approaching or exceeded by a threshold predetermined temperature which may be said to indicate a dangerous degrees of heat. If the threshold temperature is exceeded, the EVACUATE light on the fifth display 139 positioned in the upper left corner of the pocket monitor 101 (being opened) may flash in red lettering and if the pocket monitor 101 is closed, then the EVACUATE light on the fourth display 137 in the bottom left corner will flash in red lettering and vibrate.

### Function, Capability No. 7

The pocket monitor 101 may include a digital compass 125 to indicate the various directions such as North and South so as to help the firefighter to keep his bearings and to help him to navigate his way through the smoke-fire filled structure that is in question in the event that he becomes lost or disorientated.

This feature of the pocket monitor 101, as well as the gas detector 121 and the digital thermometer of the temperature detector 123 may be operational without requiring the firefighter to activate the functions with a specific command switch.

### Function, Capability No. 8

This feature of the pocket monitor 101 may be included to provide the firefighter some sense of comfort and to possibly give the family a closure in the event it has been determined that the firefighter is trapped or severely injured to the point firefighter may not be extracted alive.

When the need arises for the firefighter to use the telephone on his pocket monitor 101, the firefighter may only have to locate the telephone mode switch 127 which may be positioned on the lower right side of the open pocket monitor 101 and press the telephone switch 127 which may be labeled Telephone, and in response, a grid will appear on the top half of the pocket monitor 101 replacing the floor plans or keyboard which may have been displayed. (See Function Capability No. 3)

The grid may display a predetermined number of which may be 8 pre-programmed names of loved ones, friends, and or clergy and may display a standard telephone keypad that is provided for the firefighter to be able to dial any additional telephone number.

When the grid appears, the firefighter may simply touch the name of the person he wants to call, and in response to the touch, the connection is made to the appropriate person. The firefighter may have the option of taking the call directly through his pocket monitor 101 or through the receiver in the collar of his coat. All calls may be on a secured line and remain private.

Should the firefighter wish to make additional calls, then at the end of each call, the phone grid may re-appear and the above process may be repeated, and should the firefighter elect to free-dial instead of speed dial, the firefighter may simply enter in the number and the connection is made.

Should the firefighter not be able to reach the pocket monitor 101, then his telephone calls will be placed by his immediate Supervisor inside the Mobile Command Center 105.

### Mobile Command Center

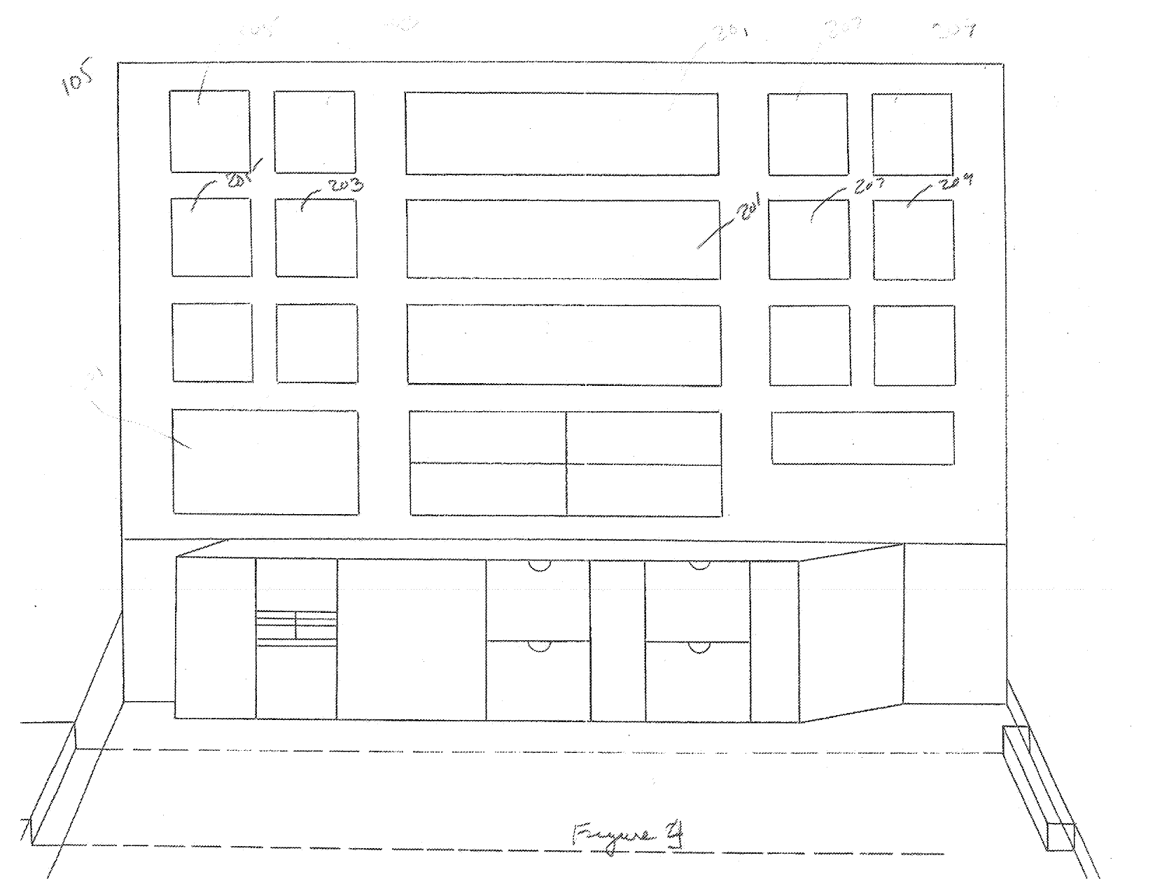

From the Mobile Command Center 105 as illustrated in FIG. 4, hereinafter, referred to by the initials (M.C.C.), the Battalion Chief, hereinafter, referred to as the (Chief), may have all of the pertinent and necessary information required and needed to assess, manage and command the developing operation where he is assigned by the 9-1-1 dispatcher.

This information may include the following (7) points, but fire officials may be permitted to add any other additional information as they deem necessary:
1. The names of all the fire stations dispatched to respond to the fire or structure in question.
2. The full names of all captains dispatched to respond.
3. The full names and number that has been assigned to the pocket monitor 101 of the individual firefighter dispatched to respond.
4. The exact and pinpointed location (floor, room, area) of the structure where the firefighter currently stands.
5. The ability to communicate with the one, more or all firefighters at the same time by 2-way radio or text message.
6. The ability to view the scene from a safe distance with the aid of a high-resolution camera mounted to the side or roof of the M.C.C. 105.
7. From the M.C.C. 105, the Chief will also have the ability to watch the fire from the perspective of any firefighter via the video camera on the firefighter pocket monitor 101.

The view of the fire from the M.C.C. 105 may always be shown on the first largest monitor inside the M.C.C. 105, and this footage shown on the monitor and any additional footage that is recorded from the firefighter perspective may be archived and preserved as evidence and or training purposes.

These (7) features available to the Chief from inside the M.C.C. May be designed help the Chief to be more efficient and give them the ability to manage and visibly watch their personnel and to better assist, locate and extract the firefighter should one or more become lost, trapped, injured, dorientated or overcome by smoke inhalation without guessing or speculating in regards to the firefighters whereabouts and without further jeopardizing or contributing to the loss of any firefighters life.

### The Fire Coat

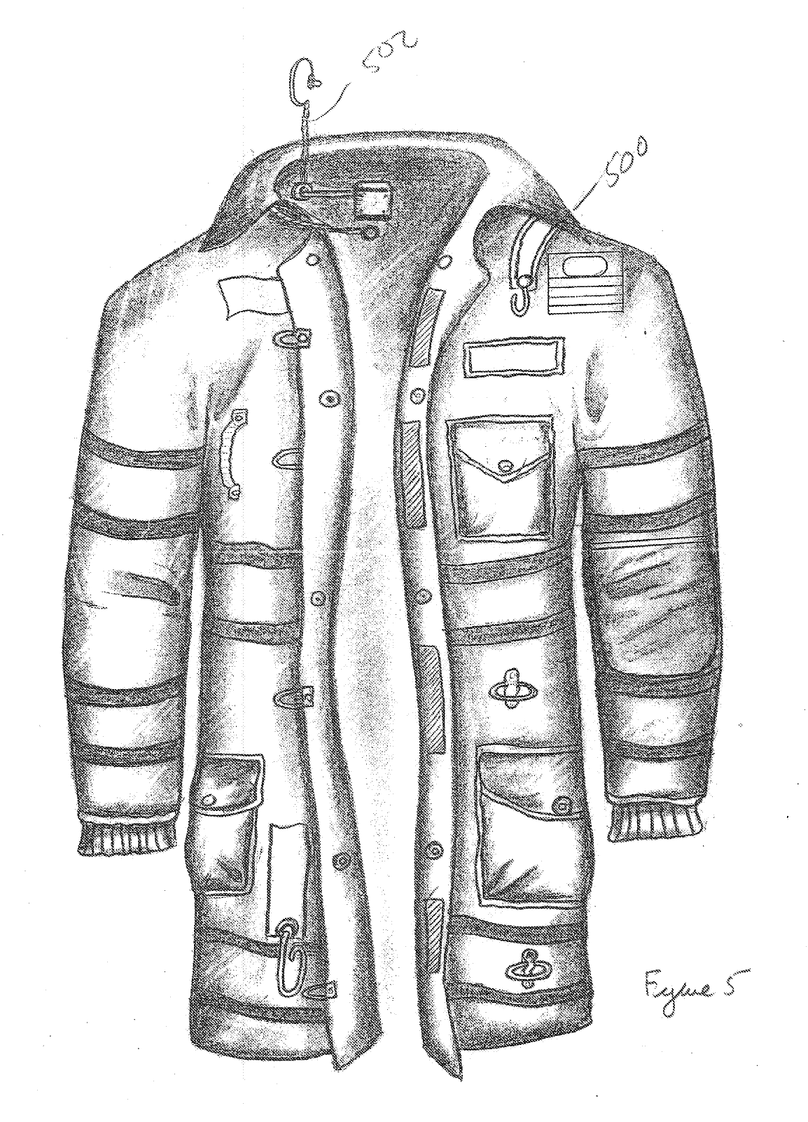

The firefighter will be issued a fire coat 500 as illustrated in FIG. 5 including a 2-way radio 502 to communicate with the M.C.C. and other firefighters at the same location or some other part of the given City which may be built in the collar of the fire coat.

The 2-way radio 502 may be an open radio, and to speak, the firefighter may wait for the channel to clear, and then identify himself by name; for example Haneef Ali, to Aiim Naszer or by Number; for example 437 to 263. Once Aiim Naszer or 263 acknowledge, then Haneef Ali or 437, may state his business. If the 2-way call is coming from the M.C.C., the call may go as, Mobile Command to Haneef Ali or M.C. to AIim Naseer or Battalion Chief to all firefighters.

In the event that the firefighter may not be able to get to his pocket monitor 101, the 2-way radio 502 in the collar may give to him the ability to communicate with the M.C.C., other firefighters and loved ones, friends and clergy. This feature may be useful if ever the firefighter is trapped and can't use his hands or has become injured or paralyzed and can't move his arm or hands.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A system for identifying and aiding a firefighter, comprising:
a pocket monitor to be carried by the firefighter;
a command center to be wirelessly connected to the pocket monitor;
wherein the pocket monitor includes a lost switch to communicate with the command center that the fire fighter is lost;
wherein the pocket monitor includes a trapped switch to communicate with the command center that the firefighter is trapped;
wherein the pocket monitor includes a injured switch to communicate with the command center that the firefighter is injured.

2. A system for identifying and aiding a firefighter as in claim 1, wherein the pocket monitor includes a video camera.

3. A system for identifying and aiding a firefighter as in claim 1, wherein the pocket monitor includes a telephone switch to enable the firefighter to make a telephone call.

4. A system for identifying and aiding a firefighter as in claim 1, wherein the pocket monitor includes a touch screen.

5. A system for identifying and aiding a firefighter as in claim 1, wherein the pocket monitor includes a temperature detector.

6. A system for identifying and aiding a firefighter as in claim 1, wherein the pocket monitor includes a compass.

7. A system for identifying and aiding a firefighter as in claim 1, wherein the pocket monitor includes a gas detector.

8. A system for identifying and aiding a firefighter as in claim 1, wherein the pocket monitor includes an evacuate display to allow the command center to evacuate the firefighter.

9. A system for identifying and aiding a firefighter as in claim 1, wherein the pocket monitor includes a text message mode switch to allow the firefighter to send and receive text messages.

10. A system for identifying and aiding a firefighter as in claim 1, wherein the pocket monitor includes a floor plan switch to display the floor plan of the building being currently occupied by the firefighter.
